(19) United States
(12) Patent Application Publication
(10) Pub. No.: US 2025/0326454 A1
(43) Pub. Date: Oct. 23, 2025

(54) Golf Cart

(71) Applicant: Vantage Tag Systems, Surrey (CA)

(72) Inventors: John Bristow, West Gosford (AU); Robert Silzer, SR., Surrey (CA); Arjun Aurora, Surrey (CA)

(21) Appl. No.: 18/072,834

(22) Filed: Dec. 1, 2022

Related U.S. Application Data
(60) Provisional application No. 63/285,026, filed on Dec. 1, 2021.

(51) Int. Cl. B62J 17/086; B62J 11/05; B62J 17/04; B62J 50/20; B62K 5/01; B62K 21/00

(52) U.S. Cl. CPC B62J 17/086; B62J 11/05; B62J 17/04; B62J 50/20; B62K 5/01; B62K 21/00

(57) ABSTRACT

A single rider golf cart is disclosed having a chassis coupled to a plurality of tires and no more than one, single occupant seat for a rider disposed about the chassis. A motor is coupled to the chassis and is configured to provide propulsion to the golf cart. A cover extends from a front of the golf cart and over the top of the single occupant seat. The cover has a first end coupled to the front of the golf cart and a rear end that is not coupled to the golf cart. The rear end is supported only by the support provide by way of the first end coupling to the front of the golf cart. A battery is disposed about the chassis of the golf cart at an elevation below a bottom of the single occupant seat.

### PRIORITY CLAIM

This application claims priority to U.S. Ser. No. 63,285,026 filed on Dec. 1, 2021, entitled Single Rider Golf Car, which is incorporated herein in its entirety. This application also claims priority to U.S. Ser. No. 29,817,489 filed on Dec. 1, 2021, entitled Single Rider Golf Cart, which is incorporated herein in its entirety.

### FIELD OF THE TECHNOLOGY

The current technology relates to improvements to golf carts, golf cart systems, and the efficient operation of golf carts, including, but without limitation, single rider golf carts.

### BACKGROUND

While outdoor activities have seen a marked increase in recent years due to the global pandemic and the social perceptions regarding the same, outdoor activities such as golfing can still put golfing pairs in close proximity. This is particularly true for riders in conventional golf carts where at least two riders are seated side-by-side. Previous attempts to design single rider golf carts failed to provide adequate accommodations to single riders. Accordingly, objects of the present invention solve previous failings.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a golf cart in accordance with one aspect of the technology;

FIG. 2 is a side view of a golf cart in accordance with one aspect of the technology;

FIG. 3 is a side view of a golf cart in accordance with one aspect of the technology;

FIG. 4 is a front view of a golf cart in accordance with one aspect of the technology;

FIG. 5 is a back view of a golf cart in accordance with one aspect of the technology;

FIG. 6 is a top view of a golf cart in accordance with one aspect of the technology;

FIG. 7 is a perspective view of a steering wheel in accordance with one aspect of the technology;

FIG. 8 is a perspective view of a steering wheel in accordance with one aspect of the technology; and

FIG. 9 is a side view of a steering wheel in accordance with one aspect of the technology.

### DETAILED DESCRIPTION OF EXAMPLE EMBODIMENTS

The following detailed description includes reference to the accompanying drawings, which form a part hereof and in which are shown, by way of illustration, exemplary embodiments. However, before the present technology is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in a fluidic or non-fluidic manner.

Objects described herein as being “adjacent to” each other may be in physical contact with each other, in close proximity to each other, or in the same general region or area as each other, as appropriate for the context in which the phrase is used.

Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.8, 3, 3.1, 4, 4.6, and 5, individually.

This same principle applies to ranges reciting only one numerical value as a minimum or a maximum. Furthermore, such an interpretation should apply regardless of the breadth of the range or the characteristics being described.

As used herein, “enhanced,” “improved,” “performance-enhanced,” “upgraded,” “improvement,” and the like, when used in connection with the description of a device, component, or process, refers to a characteristic of the device, component or process that provides measurably better form, function, or outcome as compared to previously known devices or processes. This applies both to the form and function of individual components in a device or process, as well as to such devices or processes as a whole.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

### EXAMPLE EMBODIMENTS

An initial overview of technology embodiments is provided below and specific technology embodiments are then described in further detail. This initial summary is intended to aid readers in understanding the technology more quickly, but is not intended to identify key or essential technological features, nor is it intended to limit the scope of the claimed subject matter. It should be understood that the embodiments discussed herein are contemplated for use with any type of mobile asset, and in particular, any type of vehicle that can be made to move about in the area of interest, including automobiles and other conveyances both powered and unpowered, powered and unpowered carts, mobile maintenance or grounds-keeping machines, and the like. For purposes of illustrating the various aspects of the methods and systems, the discussion below will be primarily directed to describing exemplary embodiments directed to single rider golf carts. It should be noted, however, that the elements and principles discussed herein are applicable to other mobile assets and use outside the field of golf carts. For example, references to “golf carts” in the following discussion should be understood as also generally applicable to other vehicular assets such as automobiles, riding mowers, scooters, motorcycles, all-terrain vehicles, snowmobiles, and the like.

It is also noted that discussion of methods and systems herein can be interchangeable with respect to specific embodiments. In other words, specific discussion of a method herein is equally applicable to embodiments as they relate to the system, and vice versa.

Generally speaking, aspects of the technology are directed towards a golf cart, including a single rider golf cart (or other single rider mobile vehicle). In one aspect, the single rider cart is a light weight (i.e., less than 200 kg) vehicle with a small rear cargo area sized to accommodate a standard full-size golf bag. In one aspect, the single rider cart comprises four wide tires (ranging from between 8 and 12 inches in width) coupled to rack and pinion or power steering with a turning radius of less than 2 to 3 meters. The overall center of gravity of the single rider cart is low, ranging from less than 0.3 to 0.6 meters above ground when the cart is on a horizontal surface. In one aspect of the technology, the frame of the cart comprises an alloy chassis coupled to an alloy or polymer composite windscreen frame and canopy. The windscreen comprises a split or folding windscreen with no central hinge to optimize visibility.

In one aspect, the cart is powered by a rechargeable battery (e.g., a lithium ion battery) that is disposed about the rear of the chassis at least partially beneath the rear of the chassis. In another aspect, the battery is disposed within a battery case that is seated between opposing chassis rails so that the top of the batter case is substantially level with a top of the floor of the cart. In one aspect, the battery case is disposed proximate to the rear wheels of the cart. In one aspect of the technology, the vehicle comprises a proximity sensor that is configured to couple or communicate with a corresponding sensor located on an induction mat. The battery of the vehicle is equipped with an inductive charging apparatus configured to activate when the proximity sensor indicates that the vehicle is resting atop (or sufficiently close to) the inductive mat so that charging may commence.

In one aspect of the technology, the braking system is controlled by how fast the accelerator pedal is released. In an aspect, the vehicle is equipped with a regenerative braking system. In another aspect, the vehicle comprises an additional auto electromagnetic (EM) brake on the end of the motor. An EM brake on the end of the motor automatically engages when the vehicle is stopped and automatically disengages when the accelerator pedal is pressed.

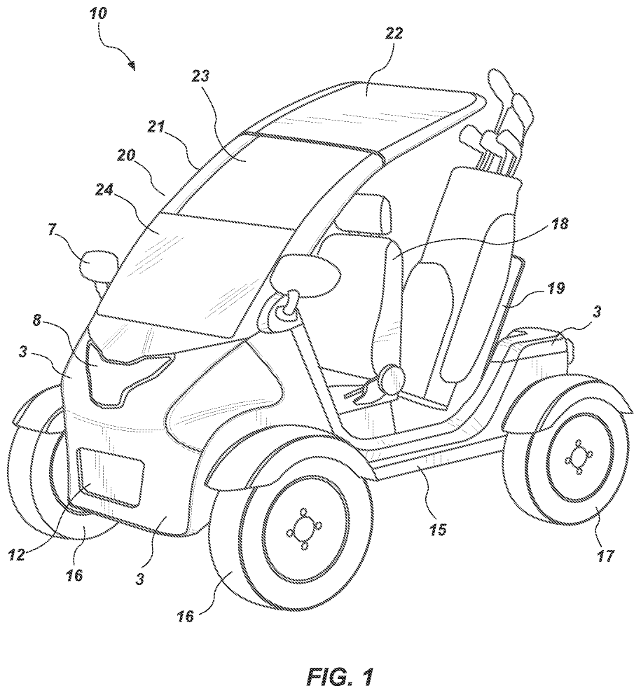

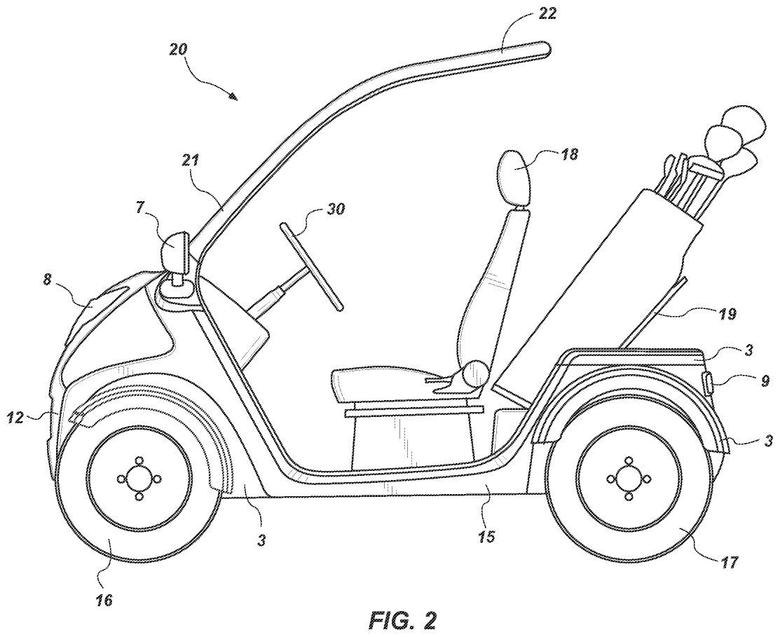

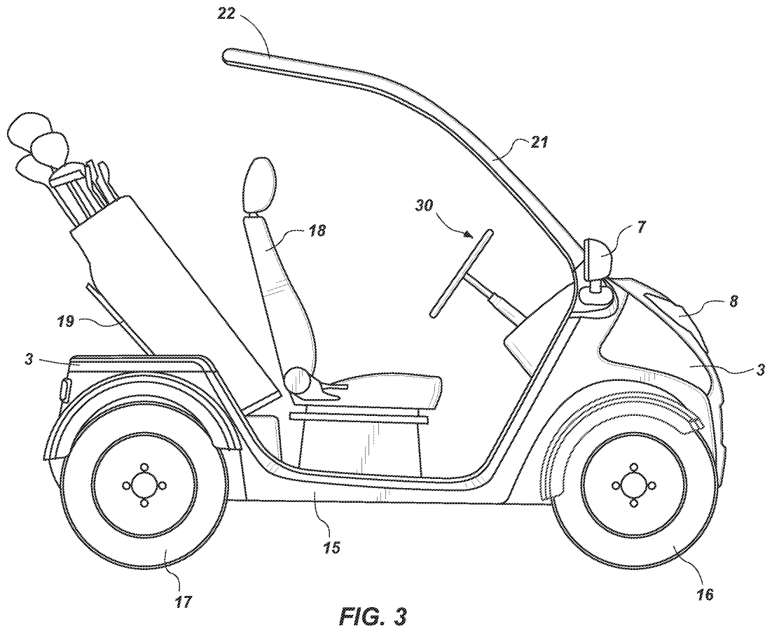

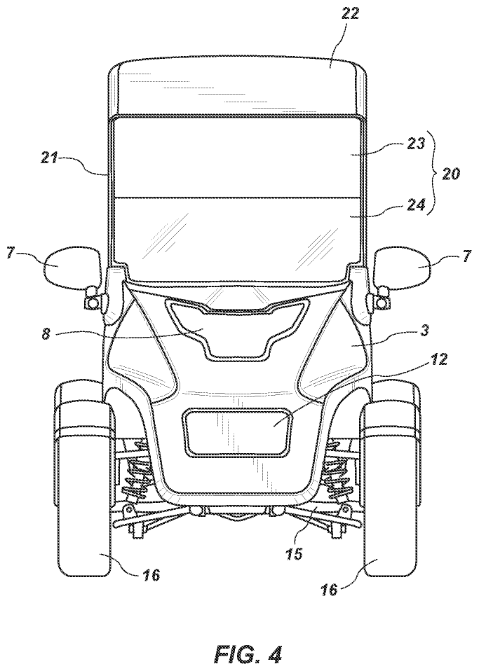

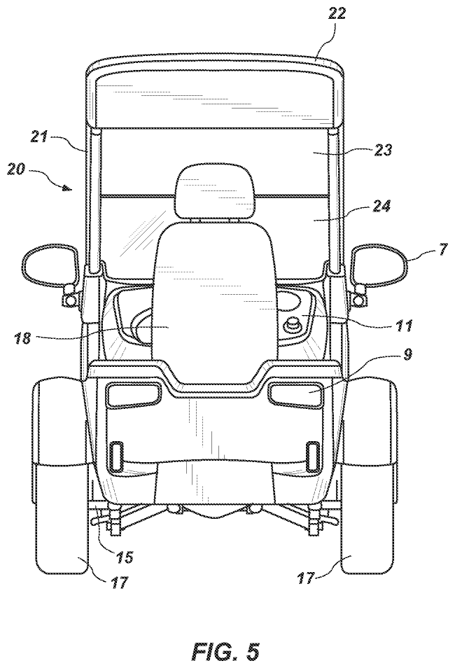

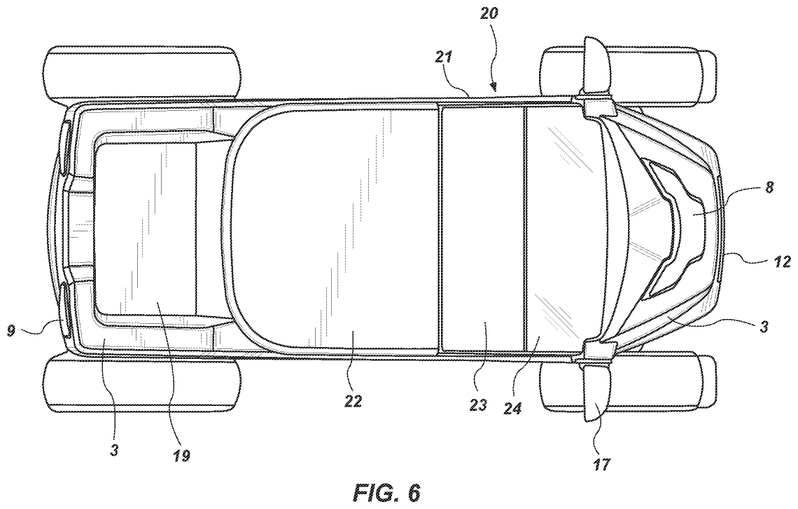

With reference now to the FIGS. 1-6, the single rider vehicle 10 comprises a frame or chassis 15 configured to couple to a front set of tires 16 and a rear set of tires 17. At least one of the front set 16 or rear set of tires 17 are coupled to an electric or gas-powered motor that drives one or both sets of the tires. In one aspect, the motor is coupled to a pedal mounted below the dash 11 of the vehicle 10 and also below the steering apparatus 30. A single rider seat 18 is mounted to the frame or chassis 15 and is centered on the frame 15 between the first and second sets of tires in a lateral direction to distribute weight evenly in a lateral direction about the vehicle 10. In one aspect, the seat 18 is located slightly behind the center of a longitudinal axis of the vehicle so the weight of the driver is slightly shifted to the rear of the vehicle to increase traction in a rear-wheel driven situation. A tray, platform, or compartment is disposed behind the seat 18 and is configured to accommodate a single golf bag of the single rider.

In one aspect, the front of the vehicle 10 does not extend significantly past the front of the front set of tires 16 or significantly past the rear of the rear set of tires 17. In this manner, the single rider vehicle 10 remains significantly compact with a shorter turning radius. In one aspect, the vehicle 10 comprises one or more side view mirrors 7 and a front head light 8 for safety as well as rear and brake lights 9. In one aspect of the technology, a foldable support 19 is disposed behind the seat 18 that is configured to be placed in a first position that supports a golf bag (or other package) in an upright but inclined orientation, a second position that supports a golf bag (or other package) in a completely upright orientation, or a third position that supports a golf bag, package, or a second seat wherein the support 19 is horizontal. In one aspect, the support 19 comprises an adaptor so that the different accessories may be located behind the seat 18. Different accessory connectors may be disposed about the adapter depending on the type of accessory to be placed behind the rider. In this manner, the vehicle may accommodate a single golf bag when one accessory connector is coupled to the adaptor, or it may accommodate a parcel holder, beverage tray, or other accessory as suits the user. In one example, the accessory connector comprises a second back-facing seat. In this manner, the single rider golf cart is converted into a double rider cart, without any golf accessories. Advantageously, the golf cart then has multiple uses.

In one aspect of the technology, the vehicle 10 comprises a front windshield/cover 20 that extends upward from the vehicle dash 11 and an angle ranging from between 30 and 60 degrees relative to an imaginary horizontal plane extending from the dash 11. The imaginary horizontal plane is parallel to a horizontal plane extending though the frame or chassis 15 of vehicle 10. In one aspect, the windshield/cover 20 extends upward at a first angle relative to the dash 11 for a first distance forming a first panel 21 and then extends upward at a second smaller angle (e.g., between 5 and 25 degrees) with respect to the dash 11 for a second distance forming a second panel 22. Importantly, there is no support beam extending downward from the first panel 21 or second panel 22 to the frame or chassis 15 in order to maximize the amount of open space for the driver of the vehicle. In this manner, the field of view of the driver remains significantly unobstructed. In one aspect, the frame that encloses the windshield/cover 20 and the material forming at least the second panel 22 comprises a lightweight material such as fiberglass, polycarbonate, or the like to minimize the weight of the cover extending over the driver of the vehicle. In one aspect of the technology, a slidable awning is disposed within, or coupled to, the second panel 22. In this manner, the slidable awning may be extending over the golf bag (or other package) located behind the seat 18. In one aspect, the awning comprises a waterproof membrane or cover.

In one aspect of the technology, a screen 12 is disposed about a front of the vehicle. The screen 12 is coupled to a cloud-based server, or other remote server, and displays, for example, the number of the vehicle, the location of the vehicle (e.g., which hole number the vehicle is currently at), the name of the rider, warnings about terrain, weather conditions, or other concerns from the course marshal.

In one aspect of the technology, the first panel 21 comprises a clear, solid material such as plexiglass or some other translucent material. The second panel can likewise comprise a translucent material but can also comprise an opaque material and can also comprise one or more solar cells coupled to a battery and/or the motor of the vehicle 10. In one aspect, the first panel 21 comprises a plurality of translucent panels that may be removed or adjusted to create an opening. For example, in one aspect, the first panel 21 comprises a first section 23 disposed above a second section 24. The first section 23 can be removed and/or slid downward adjacent to the second section 24. In an additional aspect of the technology, the first section 23 is foldable so that it can be folded into a two-piece section. In other words, in one aspect, the first section 23 comprises a bi-fold section. In this manner, the first section 23 is more easily moved upward within the frame that houses the first section 23 and second section 24. In one aspect, the frame of the first panel 21 and second panel 22 is curvilinear. The foldable first section 23 enables the first section 23 to more easily slide within the curvilinear first panel 21.

In one aspect of the technology, the body of the vehicle comprises a plurality of clip-on panels 3 that can easily be removed and replaced with minimal or no tools. In this manner, the color of the body of the vehicle can be modified at the end of the manufacturing process. Meaning, one main vehicle type can be manufactured, but the replaceable body panels 3 enable the manufacturer to change the color and/or design of the vehicle by placing different body panels 3 on the main vehicle type. Additionally, if any of the body panels 3 are damaged or weather worn, they may be replaced without significant effort. In one aspect of the technology, the frame of the vehicle comprises a plurality of holes that are configured to receive tabs placed on the body panels 3, however other types of mechanisms for removably securing the body panels 3 are contemplated herein.

In another aspect of the technology, the seat 18 comprises a lock with a release handle that allows the seat 18 to rotate 360 degrees. The seat 18 may be locked in three different positions: straight ahead, 90 degrees to the left, and 90 degrees to the right. This will permit a rider that has mobility concerns to safely exit and enter the vehicle without a concern that the seat 18 will move while ingress or egress.

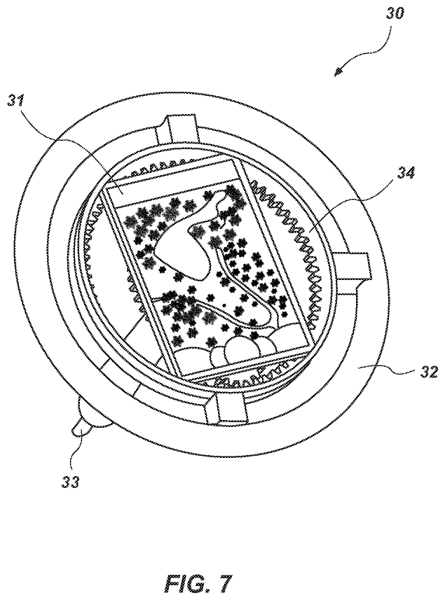

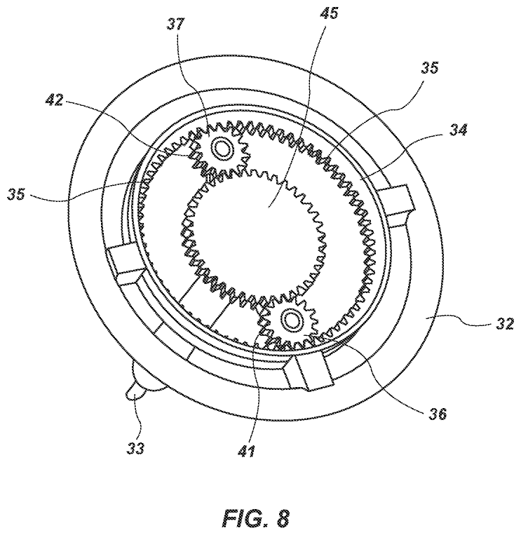

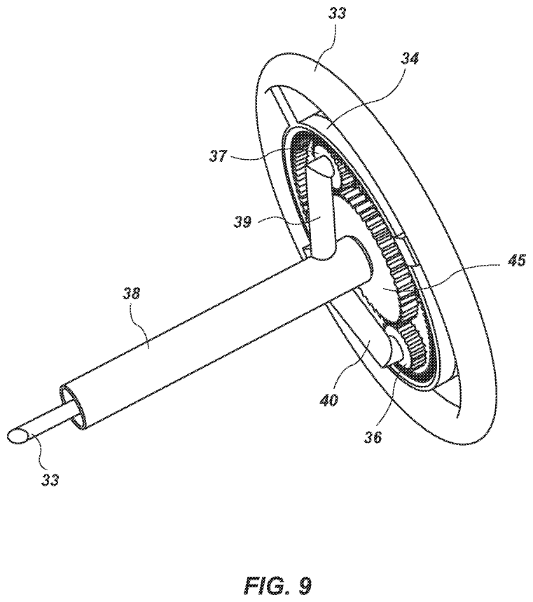

With reference to FIGS. 7-9, in one aspect of the technology, the steering mechanism or assembly 30 is configured to house a mobile device such as a tablet or mobile phone with a digital screen 31 that tracks the movement of the vehicle with respect to the terrain in which it is operating and the course on which it is located, its location within and/or relative to its designated travel group, and other functions. For example, the screen 31 is coupled to a cloud-based server, or other remote server, for communicating with the course marshal and/or other vehicles within a designated travel group. In another aspect, the screen is coupled to a rear view camera on the rear of the vehicle or back side of panel 22. The steering mechanism is configured, however, so that the screen of the mobile device or tablet 31 remains substantially in an upright position even though the wheel 32 of the steering mechanism 30 is being rotated. Advantageously, the screen 31 that is being used by the driver to navigate or review the course terrain does not change orientation, even though the steering wheel 32 to which it is mounted does change orientation. In one aspect of the technology, the steering mechanism 30 comprises a wheel 32 coupled to a main shaft 33 by why of a plurality of gears. As the wheel 32 is rotated, the main shaft likewise rotates and actuates the steering of the vehicle 10.

In one aspect, the wheel 32 is coupled to a first circular gear or sprocket 34 that is concentric with the wheel 32 and disposed within an inner perimeter of the wheel 32. As the wheel 32 is rotated, so is the first circular gear or sprocket 34. The first circular gear 34 comprises a plurality of teeth 35 disposed about its inner perimeter. The first circular gear 34 is coupled to second and third gears 36, 37. A bottom of the second and third gears 36, 37 are coupled at their center to a stationary housing 38 disposed about an exterior of the main shaft 33 by a pair of struts 39, 40. The second and third gears 36, 37 comprise teeth 41, 42, respectively, that are disposed about an exterior perimeter of the second and third gears 36, 37. The teeth 41, 42 of the second and third gears are configured to mate with the teeth 35 of the first circular gear 34. As the first circular gear is rotated, the second and third gears 36, 37 rotate about their respective axes. However, the center of the second and third gears 36, 37 are fixed as they are coupled to struts 39, 40 which are coupled to the stationary housing 38. The screen 31 is coupled, directly or indirectly, to the center of the second and third gears 36, 37 and thus is also fixed. Meaning, it does not rotate as wheel 32 is rotated.

In one aspect, the second and third gears 36, 37 extend outward from the main shaft 33 and are diametrically opposed, though they need not be. In another aspect, the second and third gears are adjacent or located on the same side of the steering mechanism 30. A fourth gear 45 is directly coupled to the main shaft 33 and acts to rotate the main shaft 33. The fourth gear 45 is concentric with the first circular gear 35 and the wheel 32. The fourth gear 45 comprises a plurality of teeth 46 about its exterior that are configured to mate with the exterior teeth 41, 42 of the second and third gears 36, 37. When acting in concert, as the wheel 32 is rotated, the first gear 35 is rotated in the same direction. Second and third gears, 36, 37 rotate in an opposite direction, having a fixed center, and the fourth gear 45 rotates in the same direction as the wheel 32 and first gear 35.

In another aspect of the technology, a plurality of vehicles comprise a designated group and are configured to travel semi-autonomously as a system. That is, a first one of the plurality of vehicles is manually controlled by a driver. The remainder of the plurality of vehicles in the designated group “follow” the first or “primary lead” vehicle in a pre-determined fashion. In one aspect, each of the plurality of vehicles is provided with an ordinal number designation (e.g., first, second, third, fourth, etc.). The first vehicle is assigned primary lead vehicle and the remaining vehicles in the designated group are “follow on” vehicles. In one aspect of the technology, when in semi-autonomous mode, the follow on vehicles are in a “lockout” mode. Meaning, they cannot be controlled by the manual steering and propulsion systems a driver would ordinarily employ. In the event of a malfunction or a need to adapt movement of a follow on vehicle while in the semi-autonomous mode, a driver may deactivate or override the lockout. In one aspect, as the primary lead vehicle is moved a first distance in a first direction, the follow on vehicles will travel the first distance in the first direction in the order of their ordinal indicator. Meaning, the second vehicle goes second, the third goes third, etc. The time between movement of each ordinal vehicle is presented by a predetermined period of time ranging from 1 second to 1 minute.

In one aspect, each of the vehicles in the designated group are coupled to a cloud-based server or other remote server so that they are all coupled to a central control. In one aspect, each vehicle is equipped with a GPS located to assist in governance of vehicle movement. In another aspect, the vehicles are equipped with ZED and Lidar sensors to efficiently manage movement of the vehicles within the designated vehicle group. For purposes of this application, Lidar means “light detection and ranging.” Lidar uses eye-safe lasers to create a 3D representation of the surveyed environment. In one aspect, the lidar sensor emits pulsed light waves from a laser all about the exterior of the vehicle. These pulses bounce off surrounding objects and return to the sensor. The sensor uses the time for each pulse to return to the sensor to calculate the distance it traveled. Repeating this process at a rate of millions of pulses per second provides information about the environment surrounding the vehicle. A chip disposed about the vehicle utilizes this information, in connection with proximity sensors assigned to each vehicle within a designated group, to maintain a predetermined distance between each vehicle in the designated travel group during travel. Advantageously, the primary lead and follow on vehicle arrangement allows for the movement of a group of vehicles with only one active driver. This helps with golf course management, for example, when a group of carts needs to be moved and only one employee is available to do so. In this manner, the employee could go to a central server and select the vehicle numbers to be included in the designated group, select the primary lead, and drive the primary lead vehicle while the other vehicles follow at the predetermined pace. Likewise, a group of golfers, for example, can be placed in a designated travel group, where the primary lead is the only actively drivable cart. This allows for each driver to have their own cart, but minimizes the likelihood that an inexperienced or impaired driver will drive out of bounds, or in a manner that is likely to harm persons or property.

In an additional aspect of the technology, the system of vehicles are equipped with a payload adjustment module. In one aspect, the primary lead vehicle is coupled to a server or memory system that tracks and/or stores the topography over which the primary lead is driving and, based on the payload of the primary lead, determines the torque required to maintain the primary lead at a predetermined velocity. Weight sensors are disposed about each vehicle determine the payload on each vehicle. When in semi-autonomous mode, each follow on vehicle is regulated based on the estimate of torque required to maintain the velocity of each particular vehicle based on the payload of each vehicle. In this manner, a third vehicle, for example, that has a significantly lighter payload will not exceed the velocity of the second vehicle and possibly causing an accident with the second vehicle.

In another aspect of the technology, the system of designated vehicles are configured with geographic marker location module such that a geographic location of the primary lead vehicle is marked when there is a change of direction and/or change in velocity of the primary lead vehicle. The marked location is communicated to the follow on vehicles, along with change in direction and the change in velocity, so that each follow on vehicle in turn changes direction and/or velocity at the marked location.

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media, implemented with any technology for the storage of information such as computer readable instructions, data structures, program modules, or other data. Computer readable storage media includes, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. By way of example and not limitation, communication media includes wired media such as a wired network or direct-wired connection and wireless media such as acoustic, radio frequency, infrared and other wireless media. The term computer readable media as used herein includes communication media.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

1. A golf cart, comprising:
a chassis coupled to a plurality of tires;
no more than one, single occupant seat for a rider disposed about the chassis;
a motor coupled to the chassis configured to provide propulsion to the golf cart;
a cover extending from a front of the golf cart and over the top of the single occupant seat, wherein the cover comprises a first end coupled to the front of the golf cart and a rear end that is not coupled to the golf cart; and
a battery disposed about the chassis of the golf cart at an elevation below a bottom of the single occupant seat.

2. The golf cart of claim 1, further comprising a proximity sensor configured to communicate with an inductive coupling mat, the battery comprising an inductive coupling assembly that is activated when the proximity sensor detects that the golf cart is located adjacent to the coupling mat.

3. The golf cart of claim 1, further comprising a forward facing digital screen disposed about a front of the golf cart.

4. The golf cart of claim 1, further comprising a compartment behind the single occupant, the compartment comprising an adaptor configured to removably receive an accessory carrying assembly.

5. The golf cart of claim 4, wherein the accessory carrying assembly is configured to accommodate a golf bag, a parcel, or a beverage cart.

6. The golf cart of claim 4, wherein the cover comprises a foldable windshield disposed therein.

7. The golf cart of claim 4, wherein the cover comprises a slidable awning configured to extend rearward of the single occupant seat and over the compartment.

8. The golf cart of claim 1, further comprising a digital screen disposed about a front of the golf cart, the digital screen configured to display information related to the golf cart identity, information from the golf marshal, or the location of the golf cart on the golf course.

9. A golf cart, comprising:
a chassis coupled to a motor, the motor configured to provide propulsion to the golf cart;
no more than one, single occupant seat for a rider disposed about the chassis;
a cover extending from a front of the golf cart and over the top of the single occupant seat, wherein the cover comprises a first end coupled to the front of the golf cart and a rear end that is not coupled to the golf cart;
wherein the cover extends in a direction from the front of the golf cart to the rear of the golf cart at an angle ranging from between 30 and 60 degrees relative to an imaginary horizontal plane, wherein the imaginary horizontal plane is parallel to an imaginary horizontal plane extending though a bottom of the chassis;
and a steering assembly disposed forward of the single occupant seat.

10. The golf cart of claim 9, wherein a first portion of the cover extends in a direction from the front of the golf cart to the rear of the golf cart at an angle ranging from ranging from between 30 and 60 degrees relative to the imaginary horizontal plane, and a second portion of the cover extends away from the first portion in a direction from the front of the golf cart to the rear of the golf cart at an angle ranging from between 5 and 25 degrees relative to the imaginary horizontal plane.

11. The golf cart of claim 10, wherein the first portion of the cover is coupled to the front of the vehicle and the second portion of the cover is only coupled to the first portion of the cover.

12. The golf cart of claim 11, wherein the steering assembly comprises a steering wheel coupled to a digital screen mounted about the steering wheel, wherein the digital screen is configured to remain in a substantially upright position irrespective of the rotation of the steering wheel.

13. The golf cart of claim 12, wherein the steering wheel is coupled to a main shaft by way of a plurality of gears.

14. The golf cart of claim 13, wherein the plurality of gears comprises a first circular gear concentric with the steering wheel and disposed within an inner perimeter of the steering wheel.

15. The golf cart of claim 14, wherein the first circular gear is coupled to second and third gears disposed within the first gear, the second and third gears coupled to the main shaft by two arms.

16. The golf cart of claim 15, wherein the second and third gears are coupled to a fourth gear disposed between the second and third gears, the fourth gear being coupled to the digital screen.

17. A golf cart system, comprising:
a plurality of golf carts, each cart comprising:
no more than one, single occupant seat for a rider disposed about a chassis;
a motor coupled to the chassis configured to provide propulsion to the golf cart;
a cover extending from a front of the golf cart and over the top of the single occupant seat, wherein the cover comprises a first end coupled to the front of the golf cart and a rear end that is not coupled to the golf cart; and
wherein each golf cart in the plurality of golf carts is designated in a travel group and assigned an ordinal number, the first golf cart in the plurality of golf carts being designated as the primary lead golf cart and the remaining golf carts in the plurality of golf carts being designated as follow on golf carts.

18. The golf cart system of claim 17, further comprising a plurality of sensors disposed on each of the plurality of golf carts, wherein each sensor on any one golf cart is configured to gather image data from other of the plurality of golf carts surrounding the one golf cart.

19. The golf cart system of claim 17, wherein the plurality of golf carts are equipped with a payload adjustment module configured to calculate a torque differential between different ones of the plurality of golf carts depending on differences in payloads.

20. The golf cart system of claim 17, wherein the plurality of golf carts are equipped with a marker location module configured to mark a location where the primary lead golf cart changes direction and/or velocity and communicates the location of the change to the follow on golf carts.
